(19) United States
(12) Patent Application Publication
(10) Pub. No.: US 2020/0137785 A1
(43) Pub. Date: Apr. 30, 2020

(54) USER EQUIPMENT (UE) AND METHOD FOR MANAGING BUFFER STATUS REPORT (BSR) FOR MULTIPLE-NUMEROLOGY OPERATION

(71) Applicant: Samsung Electronics Co., Ltd, Suwon-si (KR)

(72) Inventors: Pravjyot Singh DEOGUN, Bangalore (IN); Milos TESANOVIC, Surrey (GB); Anshuman NIGAM, Bangalore (IN)

(21) Appl. No.: 16/494,238

(22) PCT Filed: Mar. 13, 2018
(86) PCT No.: PCT/KR2018/002922

§ 371 Date: Sep. 13, 2019

(30) Foreign Application Priority Data
Mar. 13, 2017 (IN) 201741008641

(51) Int. Cl. H04W 72/12

(52) U.S. Cl. CPC H04W 72/1284; H04W 72/1268; H04W 72/1242

(57) ABSTRACT

The present disclosure relates to a pre-5^{th}-Generation (5G) or 5G communication system to be provided for supporting higher data rates Beyond 4^{th}-Generation (4G) communication system such as Long Term Evolution (LTE). User Equipment (UE) and method for managing Buffer Status Report (BSR) for multiple-numerology operation: Embodiments herein provide a method for operating a user equipment in wireless communication system. The method includes determining whether at least one of a number of LCGs with data available for transmission meets a threshold criteria and whether an available UL grant size for transmitting a BSR is less than a UL grant size threshold. Further, the method includes triggering a reduced BSR, in which the reduced BSR is at least one of a LCG index field identifying whether the at least one LCG has data available for transmission, a Coarse BSR, and a truncated BSR consisting of at least a buffer size field identifying a total amount of the data available for reporting for a LCG. The proposed method can be used to select the LCG based on a higher priority.

### CROSS-REFERENCE TO RELATED APPLICATIONS

This application is a 371 of International Application No. PCT/KR2018/002922 filed on Mar. 13, 2018, which claims priority to India Patent Application No. 201741008641 filed on Mar. 13, 2017 and India Patent Application No. 201741008641 filed on Mar. 9, 2018, the disclosures of which are herein incorporated by reference in their entirety.

### BACKGROUND

### 1. Field

The present disclosure relates to a wireless communication, and more specifically to a method for managing a Buffer Status Report (BSR) for a multiple-numerology operation.

### 2. Description of Related Art

To meet the demand for wireless data traffic having increased since deployment of 4th generation (4G) communication systems, efforts have been made to develop an improved 5th generation (5G) or pre-5G communication system. Therefore, the 5G or pre-5G communication system is also called a ‘Beyond 4G Network’ or a ‘Post Long Term Evolution (LTE) System’.

The 5G communication system is considered to be implemented in higher frequency (mmWave) bands, e.g., 60 GHz bands, so as to accomplish higher data rates. To decrease propagation loss of the radio waves and increase the transmission distance, the beamforming, massive multiple-input multiple-output (MIMO), Full Dimensional MIMO (FD-MIMO), array antenna, an analog beam forming, large scale antenna techniques are discussed in 5G communication systems.

In addition, in 5G communication systems, development for system network improvement is under way based on advanced small cells, cloud Radio Access Networks (RANs), ultra-dense networks, device-to-device (D2D) communication, wireless backhaul, moving network, cooperative communication, Coordinated Multi-Points (CoMP), reception-end interference cancellation and the like.

In the 5G system, Hybrid frequency shift keying (FSK) and quadrature amplitude modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

The principal object of the embodiments herein is to provide a UE and method for managing a BSR for multiple-numerology operation.

Another object of the embodiments herein is to determine by the UE that a number of LCGs with data available for transmission meets a LCG threshold criteria.

Another object of the embodiments herein is to determine by the UE that an available UL grant size for transmitting a BSR is less than a UL grant size threshold.

Another object of the embodiments herein is to trigger a reduced BSR in response to determining that at least number of LCGs with data available for transmission meets the LCG threshold criteria and the available UL grant size for transmitting a BSR is less than a UL grant size threshold.

### SUMMARY

Accordingly, the embodiments herein provide a method for operating a user equipment in wireless communication system. The method includes determining whether at least one Logical Channel Groups (LCG) having data available for transmission meets an LCG threshold criteria whose buffer status is to be reported. Further, the method includes determining whether an available Uplink (UL) grant size to be less than size of a long BSR and triggering a reduced BSR wherein the reduced BSR is at least one of a Truncated BSR and a Course BSR and a LCG index field identifying at least one LCG having data available for transmission.

In an embodiment, the LCGs whose buffer status is being reported is determined based on the available UL grant size.

In an embodiment, the LCG threshold criteria indicates that the number of LCGs with data available for transmission is greater than a minimum threshold but less than a maximum threshold

In an embodiment, the truncated BSR comprises at least information of data available for transmission for at least one of the LCGs.

In an embodiment, the LCGs with the data available for transmission in the truncated BSR are selected based on one of a decreasing order of a priority of LCGs for which the reduced BSR is triggered.

In an embodiment, clearing the buffer status reporting triggers of LCGs whose buffer status is being reported using the reduced BSR.

Accordingly, the embodiments herein provide a UE in wireless communication system. The UE includes a BSR engine operably coupled to a memory and a processor. The BSR engine is configured to determine at least number of LCGs with data available for transmission meets a LCG threshold criteria and available UL grant size for transmitting a BSR is less than a UL grant size threshold. Further, the BSR engine is configured to trigger a reduced BSR, in which the reduced BSR includes a LCG index field identifying whether the at least one LCG has data available for transmission, a coarse BSR, and a truncated BSR comprising of at least a buffer size field identifying a total amount of the data available for reporting for a LCG.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

The present invention provides a UE and method for managing a buffer status report (BSR) for multiple-numerology operation in wireless communication system.

### BRIEF DESCRIPTION OF THE DRAWINGS

This method is illustrated in the accompanying drawings, throughout which like reference letters indicate corresponding parts in the various figures. The embodiments herein will be better understood from the following description with reference to the drawings, in which:

FIG. 1 illustrates a MAC/PHY connection, wherein a MAC entity is connected to a multiple numerology, according to a prior art;

FIG. 2 is a block diagram illustrating various hardware components of a UE, according to an embodiment as disclosed herein;

FIG. 3 is a block diagram illustrating various hardware components of a BSR engine of the UE, according to an embodiment as disclosed herein;

FIG. 4 block diagram representing a reduced BSR reporting format, according to an embodiment as disclosed herein; and

FIG. 5 is a flow diagram illustrating various operations for managing a BSR for multiple-numerology operation, according to an embodiment as disclosed herein.

### DETAILED DESCRIPTION

Third Generation Partnership Project (3GPP) 5th generation telecommunication is expected to support a wide range of services including an enhanced mobile broadband, an ultra-reliable and a low latency communication, massive machine type communications, etc. Each service has its own specific set of requirements, which is expected to be catered by a cellular network. For instance, the enhanced mobile broadband requires high speed of data transfer, the ultra-reliable low latency communication requires data transfer with very low latency but may not require high data rate, while massive machine type communications may have the requirement to minimize User Equipment (UE) power consumption and faster data communications. Such requirements continue to hold true for any future wireless technology.

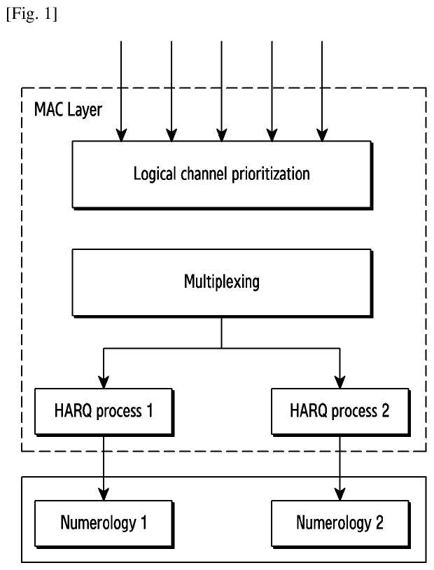

In order to cater the different requirements, the cellular network can partition radio resources such that each set of radio resources can meet the requirements of a given service by using different physical layer configurations. This is also called Radio Access Network (RAN) slicing. In 5G system, it would be possible for a UE to access multiple services concurrently, hence RAN procedures are required to be designed such that different physical layer configurations can be operated efficiently by the UE without hampering any of the service requirements. It is expected that single Medium Access Control (MAC) entity could possible support multiple physical layer configurations or numerologies simultaneously, as shown in FIG. 1. Hence, many MAC procedures (e.g. buffer status report (BSR), multiplexing, scheduling request) are expected to be common for different physical numerologies.

In current Long-Term Evolution (LTE) system, the BSR is used to report a data available for transmission of each Logical Channel Group (LCG). The LTE system has three types of BSR, which are given below:
Short BSR: BSR of a LCG
Truncated BSR: BSR of highest priority LCG which has data available for transmission; used in padding BSR
Long BSR: Information about data available for transmission for all LCGs
The BSR is triggered in the LTE whenever:
data becomes available for transmission for the LCG which has higher priority than the priorities of the Logical Channel Groups (LCGs) for which data is already available for transmission
data becomes available for transmission for the LCG and no other LCG has any data available for transmission
expiry of periodic BSR-Timer or retx BSR-Timer when UE has data available for transmission
if MAC padding bits can include BSR MAC CE

For a side-link BSR reporting, the UE can transmit the truncated BSR which contains BSR information for as many LCG values which can be accommodated in an Uplink (UL) grant. However, the issue with the LTE system is that, there is no differentiation between different physical layer configurations/numerology with respect to the BSR reporting and hence the LTE BSR mechanism is not able to provide buffer status values corresponding to uplink data transmission for a physical layer configuration/numerology. Moreover, no consideration is provided to ensure BSR values for certain low latency services which are provided as soon as possible to inform the network about updated BSR.

Further, a buffer status mechanism in 5G is expected to support an increased number of LCG (such as 8 bits) as compared to LTE. Also, a size of buffer has been increased (i.e., 8 bits) resulting in significant overhead in the BSR. In LTE, the UE always report buffer status for all LCGs if more than one LCG had data available for transmission. However, owing to increased number of LCGs, UE may not be able to follow the same principle if a small UL grant size is provided. For instance, consider in the LTE, the entire BSR for 8 LCGs amounts to 64 bits and, and if the UE got only UL grant of 32 bits then, the UE does not able to transmit the entire BSR for all LCGs. In such case, it is essential to reduce the size for BSR to accommodate the important LCG data within the BSR by considering the available grant size. Hence, the UE would not be able to transmit the BSR for important logical channel groups in significant number of instances, leading to a grant calculation error by the network.

The above information is presented as background information only to help the reader to understand the present invention. Applicants have made no determination and make no assertion as to whether any of the above might be applicable as prior art with regard to the present application.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The embodiments of the proposed method is adopted in the technical specification of 3GPP TS 38.321 version V15.0.0.

Accordingly the embodiments herein provide a method for managing a BSR for multiple-numerology operation. The method includes determining by a UE at least number of LCGs with data available for transmission meets a LCG threshold criteria and an available UL grant size for transmitting a BSR is less than a UL grant size threshold. Further, the method includes triggering by the UE a reduced BSR, in which the reduced BSR is at least one of a LCG index field identifying whether the at least one LCG has data available for transmission, a coarse BSR, and a truncated BSR comprising of at least a buffer size field identifying a total amount of the data available for reporting for a LCG.

Unlike conventional systems and methods, the proposed method triggers the reduced BSR, which allows the UE to transmit information of more than one LCGs within the UL grant size, even when the uplink grant size is not enough to accommodate a long BSR. Further, the proposed method can be used to select the LCG based on a higher priority. In the proposed method, the LCGs in the reduced BSR are selected based on the priority of the logical channels within the LCGs. Hence, the proposed method can support any critical information of buffer size.

Unlike conventional systems and methods, the proposed method provides the higher flexibility for the UE, so that the LCGs of different numerologies can be mixed, and the UE can transmit only one LCG report and provide an indication of highest priority data in that LCG.

Unlike conventional systems and methods, the proposed method can be used to selectively cancel the BSR triggers based on the LCGs which are included within a transmitted BSR.

In an embodiment, BSR procedure mentioned in the proposed method can be applicable for any wireless technology and not restricted to the 3rd Generation Partnership Project New Radio (3GPP NR) technology, LTE system, 5G, Universal Mobile Telecommunications System (UMTS), and Worldwide Interoperability for Microwave Access (WiMAX) systems.

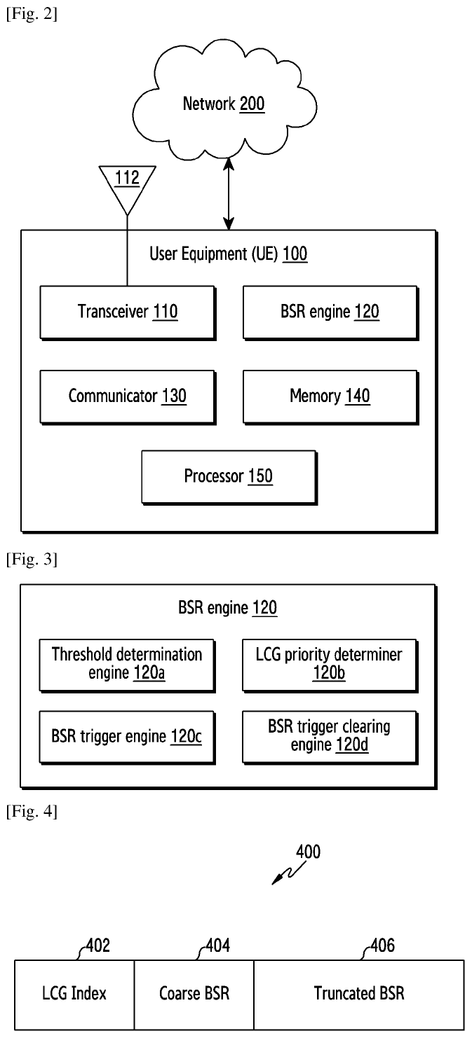

Referring now to the drawings, and more particularly to FIGS. 2 through 5, there are shown preferred embodiments.

FIG. 2 is a block diagram illustrating various hardware components of a UE 100, according to an embodiment as disclosed herein. The term UE used in the description can include, for e.g., cellular telephones, smartphones, mobile stations, personal computers (PCs) and minicomputers, desktops, laptops, or otherwise, as well as mobile devices such as handheld computers, PDAs, personal media devices (PMDs), or the like. The UE 100 is configured to connect with a network 200 via a wireless communication link. The network 200 can be, for example, a cellular network, Radio Access Network (RAN), 4G network, 5G network or any wireless communication network.

In an embodiment, the UE 100 includes a transceiver 110, a BSR engine 120, a communicator 130, a memory 140, and a processor 150. The transceiver 110 is coupled with an antenna 112, and can be configured to communicate with the network 200. The transceiver 110 can be configured to transmit a BSR to the network 200 where the BSR is a MAC layer message indicates the information (i.e., size) of data to be reported. Further, the transceiver 110 can be configured to receive a UL grant size from the network 200 for transmitting the data. Further, the network 200 can be configured to allocate a minimum amount of UL grant, if a resource is available.

In an embodiment, a single MAC entity in the UE 100 can be configured to operate a multiple physical layer configurations simultaneously. The UE 100 can be configured to trigger the BSR includes the data to be transmitted using different numerologies/Transmission Time Intervals (TTI) to inform the network 200 about the data available for transmission of different services. In an embodiment, all logical channels within the LCGs are mapped or associated to same set of numerology/TTI values. In an embodiment, different LCGs can be mapped to different numerology/TTI values.

In an embodiment, the BSR engine 120 is configured to determine at least number of LCGs with data available for transmission meets a LCG threshold criteria and an available UL grant size for transmitting a BSR is less than a UL grant size threshold. The LCG threshold criteria indicates that the number of LCGs with data available for transmission is greater than a minimum threshold but less than a maximum threshold. The network 200 can be configured to define the minimum threshold value and the maximum threshold value.

In an embodiment, the BSR engine 120 is configured to trigger a reduced BSR. In an embodiment, the reduced BSR includes a LCG index field identifying whether the at least one LCG has data available for transmission, a coarse BSR, and a truncated BSR includes a buffer size field identifying a total amount of the data available for reporting for a LCG.

In an embodiment, the UE 100 configured with a unit of BSR reporting quantization as data available for transmission per LCG. However, any other quantization unit reporting is not precluded using coarse BSR and same procedures can be applied as defined herein. In an embodiment, the BSR engine 120 is configured to use any of the following BSR format:

Short BSR: The BSR engine 120 reports the data available for transmission for only one LCG. The short BSR can be reported when only one LCG has data available for transmission.

Reduced BSR: In an embodiment, the reduced BSR includes at least of a LCG index field identifying whether the at least one LCG has data available for transmission, a coarse BSR, and a truncated BSR comprising of at least a buffer size field identifying a total amount of the data available for reporting for a LCG. For a BSR, the BSR engine 120 is configured to determine whether available uplink grant size for transmitting a BSR is smaller than the size of the long BSR. Further, the BSR engine 120 is configured to determine the number of LCGs having data available for transmission when the BSR is to be transmitted.

If the available uplink grant size for transmitting a BSR is smaller than the size of the long BSR and, the number of LCGs having data available for transmission when the BSR is to be transmitted is greater than a predefined threshold then, the BSR engine 120 is configured to report reduced BSR of the LCG(s) with the logical channels having the data available for transmission following a decreasing order of priority.

Long BSR: if the available uplink grant size for transmitting a BSR is equal to or larger than the size of the long BSR then, the BSR engine 120 is configured to report long BSR for all LCGs which have data available for transmission. The long BSR report may be prohibited to transmit on certain conditions on account of its high overhead, e.g. when uplink grant size is small or when uplink grant is received for a selective physical layer numerology.

The Reduced BSR: In an embodiment, the UE 100 reports the data available for transmission for a subset of available LCGs and/or with different granularity of an available data as compared to the short BSR and the long BSR. The reduced BSR is used to reduce an overhead of transmission of full BSR but contains more information as compared to the short BSR. Further, the multiple formats of reduced BSR can be used by UE 100 for different use cases, for e.g. reduced BSR format for different numerology/TTI can be different. In an embodiment, the UE 100 cannot be able to transmit a full BSR, as the UL grant size is small and the number of numerologies.

In an embodiment, the reduced BSR can be in form of coarse BSR and/or truncated BSR

In an embodiment, the coarse BSR is defined as one of more of following:
Reduced granularity (e.g. less number of bits) of data available for transmission for the LCG as compared to the short BSR and the long BSR. The report contains data available for transmission for all LCGs.
Quantization of reporting unit is a group of LCGs (e.g. one reporting field in the BSR indicates combined data available for transmission from the LCG0 to the LCG3, other reporting field in BSR indicates combined data available for transmission from LCG4 to LCG6, and so on). The report contains combined amount of data available for transmission for groups of LCGs.

In an embodiment, the truncated BSR contains information about the data available for transmission for N number of LCGs and their corresponding LCG index. The value of N can be flexible in length (i.e. value of N is determined based on uplink grant size available) or the value of N can be fixed in length (e.g. network 200 may indicate maximum value of N to be used for each numerology or Transmission Time Interval (TTI) or cell) or a combination of both, e.g. value of N is flexible but has a maximum limit.

In an embodiment, the BSR engine 120 is configured to select the LCGs having the data available for transmission in the truncated BSR based on the LCG priority (e.g. only highest priority LCGs are included, or more generally the N LCGs with highest priority) for which BSR is triggered.

Further, the BSR engine 120 is configured to define the priority of LCG in cases where the logical channels (LCs) of disparate priority are grouped into a single LCG by one or more of following:
Priority value of highest priority LC containing data available for transmission within the LCG
Each LCG is associated with a priority value which is configured by the network 200 or determined by the UE 100 based on highest priority logical channel of the LCG

In an embodiment, the BSR engine 120 is configured to select the LCGs based on the TTI values linked to various LCGs (e.g. TTI for LC of highest priority).

In an embodiment, gNodeB (gNB) can implicitly indicate to the UE 100 that the LCGs is requesting the buffer status report (as opposed to via RRC signaling) based on parameters of the UL grant. Based on the indication from the gNB, the BSR engine 120 is configured to select the LCGs.

In an embodiment, the BSR engine 120 is configured to select the LCGs which are associated to the numerology/TTI, for which the UE 100 has received the UL grant from the network 200. Further, the mapping can be derived using a logical channel mapping to numerology/TTI.

In an embodiment, the BSR engine 120 is configured to select the LCGs based on masking or network configuration, e.g. only those LCG values are selected for the numerology/TTI which are not masked (or configured for the numerology/TTI) by the network 200.

In an embodiment, the network 200 may initiate a request to the UE 100 to transmit the BSR for a subset of LCG. The network 200 may provide this request by MAC Control Element (CE) or Downlink Control Information (DCI) and the request includes the information about LCG values. Based on the request from the network 200, the BSR engine 120 is configured to select the LCGs.

In an embodiment, a combination of the coarse BSR and the truncated BSR can be used together to report the reduced BSR. For example, for a very short TTI the BSR engine 120 can report the coarse BSR initially, and then, in general, the UL grant will follow very promptly. The BSR engine 120 can send the truncated BSR in a next round (with the first grant).

Further, the UE 100 may also include other information along with the reduced BSR, e.g. total amount of data available for transmission in all LCGs and/or index of LCGs for which data is available and is greater than the LCG threshold criteria and/or index of LCGs for which duration between time instance when their corresponding BSR was triggered and current time is greater than the LCG threshold criteria.

BSR format selection: In an embodiment, if uplink (UL) grant size is less than a threshold then the BSR engine 120configured to trigger the reduced BSR. The UL grant size threshold can be determined as one or more of following:
The value of UL grant size threshold is determined based on size of the long BSR (e.g. multiplication factor of size of long BSR where the multiplication factor is defined by the network 200 and allows the UE 100 to include UL data in the allocated grant size)
The value of UL grant size threshold can be configured by cellular network 200 via system information or using direct message to UE 100.

In an embodiment, the UE 100 selects the BSR format based on the number of LCGs which have data available for transmission under the following conditions:
The network 200 may configure a maximum threshold and minimum threshold.
If the number of LCGs with data available for transmission is less than the minimum threshold then, the BSR engine 120 reports the short BSR.
If the number of LCGs with data available for transmission is greater than the minimum threshold but less than maximum threshold then, the BSR engine 120 reports the reduced BSR.
If the number of LCGs with data available for transmission is greater than the maximum threshold then, the BSR engine 120 reports the Long BSR.

In an embodiment, the BSR engine 120 is configured to send the reduced BSR or short BSR only if the UE 100 receives the UL grant for pre-defined numerologies/TTI values. The numerology/TTI indices can be provided by cellular network 200, where the reduced BSR is transmitted. The cellular network 200may also configure a range of TTI values for which the reduced BSR is transmitted.

BSR clearing procedure: In an embodiment, the BSR engine 120 is configured to clear the buffer status reporting triggers of LCGs whose buffer status is being reported using the reduced BSR. In an embodiment, when the UE 100 transmits the BSR, the UE 100 clears or cancels the triggered BSRs based on following procedures:

In an embodiment, the selected BSRs are cleared if the reduced BSR is used or reported BSR does not contain information about all the available LCGs. The UE 100 clears one or more of the following BSRs:

Each BSR, when triggered, is associated with an LCG value. The BSR triggered due to data available for transmission is associated to LCGs for which data has become available. The BSR triggered due to retransmission (retx)-BSR-Timer expiry is associated to all LCGs which have data available for transmission. The BSR triggered due to periodic-BSR-Timer expiry may be associated to either all the LCGs for which data is available for transmission or is associated to all possible LCG values. If the BSR is transmitted by UE 100 to the network 200 and contains buffer status for a set of LCGs, then all the triggered BSRs are cleared/cancelled which are associated only to the given set of LCGs.
Only BSRs triggered due to regular BSRs are cleared.
Only BSRs triggered due to periodic BSRs are cleared.

In an embodiment, no triggered BSR is cleared if report does not contain information about all the LCGs for which data is available.

Controlling the LCGs for which BSR is transmitted: The reduced BSR may not contain information about all the possible LCG values for which data is available for transmission. The UE 100 may in that case be required to transmit BSR for remaining LCG values at the next available opportunity. If UE 100 clears all the triggered BSRs, then the network 200 may not get buffer status information of the LCGs which were not included in BSR sent by UE. On the other hand, if no BSR is cleared, then the next BSR will contain information about the same set of LCGs which were previously reported.

In an embodiment, a possible way to resolve this issue is by at least one of only clearing subset of the BSRs (i.e. BSRs which contain information about LCGs which UE 100 has already indicated to network 200 should be cleared) or a UE 100 maintaining list of LCGs for which buffer indication is not provided to the network 200.

In an embodiment, the UE 100 selects the LCG values for which BSR transmission is required according to one or more of following:
If only selected BSRs are cleared as defined previously, the UE 100 when including BSR, only considers the LCG values for which BSRs are triggered and not cancelled/cleared.
If no triggered BSRs are cleared when reduced BSR is transmitted, the UE 100 maintains a list of LCG values. This list is used by the UE 100 to check the LCGs for which buffer status needs to be indicated to the network 200. The list is maintained according to:
   When a regular BSR is triggered due to data becoming available for transmission for the LCG, UE 100 adds the LCG value to the list (if not included already)
   When the regular BSR is triggered due to expiry of retx-BSR-Timer, the UE 100 adds all the possible LCG values to the list for which data is available for transmission
   When periodic BSR is triggered, the UE 100 adds all possible LCG values (or only LCG values for which data is available)
   If a BSR is transmitted, the UE 100 removes all the LCG values from the list for which BSR is reported
   The UE 100 when including BSR, only considers the LCG values which are present in the list

BSR Triggering Condition: In the LTE, all BSRs are cleared when the BSR is transmitted by the UE 100 to the network 200. But after reporting BSR, there is still some time before all the buffered data can be transmitted and cleared by the UE 100. For example, consider a scenario in which only one logical channel contains data for transmission. If the BSR is transmitted at time T1 and the network 200 responding with UL grant at time T2, any data which comes in the logical channel buffer between T1 and T2 will not trigger a BSR. Hence, the possible instances where BSR can be reported for this new data are:
expiry of periodic BSR-Timer or retx BSR-Timer
Padding BSR

Hence, there is buffer state mismatch between the network 200 and the UE 100 during this time. Since, the padding BSR is only sent on availability of empty radio resource after data inclusion, the padding BSR cannot be transmitted when the UE 100 has more amount of data available than reported to the network 200. As, periodic BSR cannot generate a scheduling request, so only retx BSR-Timer would be able to report buffer status of new data. This may lead to high delay as value of retx BSR-Timer is kept high.

In an embodiment, the proposed method can be used to address the above issue:

The network can be configured to transmit the UL grant for the UE 100, when UE's periodic BSR timer expires:
The network 200 may transmit additional UL grant only for a selected number of use cases (e.g. for low latency service or for a set of numerology/TTI values or for a logical channel set which requires a specific quality of service).
The network 200 may configure different periodic BSR timer values for different LCGs or numerologies or TTI values in order to ensure that for some use cases (e.g. low latency service) UE 100 can transmit updated BSR quickly

The network 200 allocates more UL resources than required for last UL grant so that UE 100 can transmit padding BSR along with UL data. The UL grant size requirement is determined based on previous BSR transmitted by UE 100.

The network 200 may configure different value of retx BSR-Timer (for e.g. small value of low latency service or for a subset of numerology/TTI values) to ensure that UE 100 may indicate the updated BSR to the network 200 as early as possible.

By using procedure of selective BSR clearance as explained in the BSR clearing procedure.

BSR can be generated for some LCGs when more data arrives for transmission. The complete description of procedure is as follows:
The restriction where BSR is generated is as follows:
   In an embodiment, the BSR is generated only for a selective number of logical channels or LCGs, which can be configured by the network 200.
   In an embodiment, the BSR cannot be generated when the value of retx BSR-Timer is less than a threshold or if time of expiry of retx BSR-Timer is less than the threshold
As this procedure may lead to a frequent BSR transmissions, additional mechanism is used to control the frequency of generation of BSRs.
   The UE 100 initiates a timer when more data becomes available for transmission for a set of LCGs but no BSR is triggered
   The timer may be associated to a set of LCGs
   The length of the timer can be same as retransmission timer or can be configured by the network 200
   As long as timer is running, if more data arrives for the given set of LCGs no BSR is generated
   The timer is stopped if a BSR is transmitted containing data report for the associated LCGs
   When the timer expires, a regular BSR is triggered associated to the LCGs for which data is available for transmission

Further, the network 200 may request the UE 100 to report BSR for the selected number of LCGs. The network 200 may initiate this request using MAC CE or DCI signaling, and the request may contain information on set of LCGs for which report is required.

In an embodiment, the proposed method consider that the BSR contains report of data available for transmission per LCG and all logical channels within an LCG are mapped or associated to same set of numerology/TTI values. But it is possible in some scenarios to include more information in BSR. For example, when there are subgroups within an LCG (which may be associated to a specific numerology), it is required to indicate data available for transmission for each subgroup. Hence, smallest quantization of reporting in such a scenario is subgroup within an LCG. All the above procedures are applicable for this scenario as well by replacing the LCG index by group of LCG subgroup index and LCG index.

In an embodiment, the communicator 130 is configured to communicate with the network 200 and internally between hardware components in the UE 100. In an embodiment, the processor 150 can be configured to interact with the hardware components such as the transceiver 110 and the memory 140 in the UE 100 for managing the BSR for multiple-numerology operation. Further, the processor 150 is configured to process various instructions stored in the memory 140 for managing the BSR for multiple-numerology operation.

The memory 140 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 140 may, in some examples, be considered a non-transitory storage medium. The term “non-transitory” may indicate that the storage medium is not embodied in a carrier wave or a propagated signal. However, the term “non-transitory” should not be interpreted that the memory 140 is non-movable. In some examples, the memory 140 can be configured to store larger amounts of information than the memory. In certain examples, a non-transitory storage medium may store data that can, over time, change (e.g., in Random Access Memory (RAM) or cache).

Although the FIG. 2 shows various hardware components of the UE 100 but it is to be understood that other embodiments are not limited thereon. In other embodiments, the UE 100 may include less or more number of components. Further, the labels or names of the components are used only for illustrative purpose and does not limit the scope of the invention. One or more components can be combined together to perform same or substantially similar function of managing the BSR for multiple-numerology operation.

FIG. 3 is a block diagram illustrating various hardware components of the BSR engine 120 of the UE 100, according to an embodiment as disclosed herein. In an embodiment, the BSR engine 120 includes a threshold determination engine 120a, a LCG priority determiner 120b, a BSR trigger engine 120c and a BSR trigger clearing engine 120d.

In an embodiment, the threshold determination engine 120a is configured to determine the at least number of LCGs with data available for transmission meets the LCG threshold criteria and the available UL grant size for transmitting a BSR is less than the UL grant size threshold.

In an embodiment, the LCG threshold criteria indicates that the number of LCGs with data available for transmission is greater than the minimum threshold but less than the maximum threshold. In an embodiment, the UL grant size threshold is defined based on the size of the long BSR.

In an embodiment, the LCG priority determiner 120b is configured to select the LCGs having the data available for transmission in the reduced BSR based on decreasing order of the priority of LCGs for which the reduced BSR is triggered.

In an embodiment, the BSR trigger engine 120c is configured to trigger the reduced BSR. In an embodiment, the reduced BSR includes the LCG index field identifying whether the at least one LCG has data available for transmission, the coarse BSR, and the truncated BSR including buffer size field identifying the total amount of the data available for reporting for the LCG.

In an embodiment, the LCGs whose buffer status is being reported is determined based on the available uplink grant size.

In an embodiment, the BSR trigger clearing engine 120d is configured to clear the buffer status reporting triggers of LCGs whose buffer status is being reported using the reduced BSR.

Although the FIG. 3 shows various hardware components of the BSR engine 120 of the UE 100 but it is to be understood that other embodiments are not limited thereon. In other embodiments, the BSR engine 120 may include less or more number of components. Further, the labels or names of the components are used only for illustrative purpose and does not limit the scope of the invention. One or more components can be combined together to perform same or substantially similar function of managing the BSR for multiple-numerology operation.

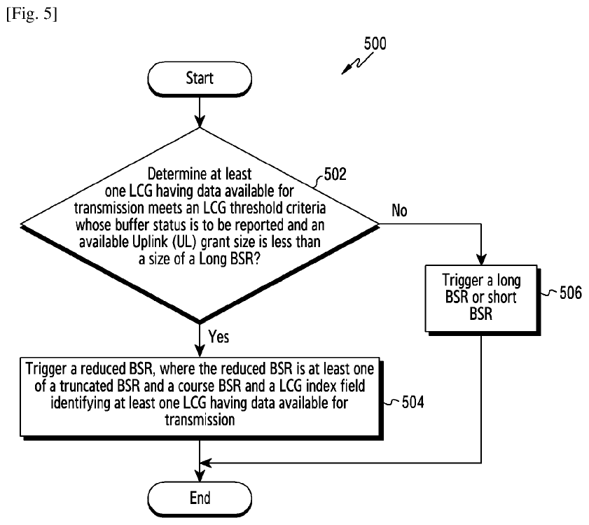

FIG. 4 a block diagram representing the reduced BSR reporting format, according to an embodiment as disclosed herein. In an embodiment, the UE 100 triggers the BSR, where the buffer status reporting includes a LCG index field 402, a coarse BSR field 404, and a truncated BSR field 406.

In an embodiment, the LCG index field 402 identifies a group of logical channel(s) which have data available for transmission.

In an embodiment, the truncated BSR field 406 includes at least the total amount of data available for reporting a LCG.

FIG. 5 is a flow diagram 500 illustrating various operations for managing the BSR for multiple-numerology operation, according to an embodiment as disclosed herein.

At 502, the method includes determining the number of LCGs with data available for transmission meets the LCG threshold criteria and the available UL grant size for transmitting a BSR is less than the UL grant size threshold. In an embodiment, the method allows the threshold determination engine 120a to determine the at least one of the number of LCGs with data available for transmission meets the LCG threshold criteria and the available UL grant size for transmitting a BSR is less than the UL grant size threshold.

If the number of LCGs with data available for transmission meets the LCG threshold criteria and the available UL grant size for transmitting a BSR is less than the UL grant size threshold then at 504, the method includes triggering the reduced BSR. In an embodiment, the method allows the BSR trigger engine 120c to trigger the reduced BSR.

In an embodiment, the reduced BSR includes the LCG index field 402 identifying whether the at least one LCG has data available for transmission, the coarse BSR field 404, and the truncated BSR field 406 comprising of a total amount of the data available for reporting for a LCG.

If the number of LCGs with data available for transmission does not meet the LCG threshold criteria and the available UL grant size is not less than the UL grant size threshold then at 506, the method includes triggering the long BSR or the short BSR. In an embodiment, the method allows the BSR trigger engine 120c to trigger the long BSR or the short BSR.

The various actions, acts, blocks, steps, or the like in the flow diagram 500 may be performed in the order presented, in a different order or simultaneously. Further, in some embodiments, some of the actions, acts, blocks, steps, or the like may be omitted, added, modified, skipped, or the like without departing from the scope of the invention.

The embodiments disclosed herein can be implemented through at least one software program running on at least one hardware device and performing network management functions to control the elements. The elements shown in the FIGS. 2 through 5 include blocks which can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

1. A method for operating a user equipment (UE) in wireless communication system, the method comprising:
determining whether at least one Logical Channel Groups (LCG) having data available for transmission meets an LCG threshold criteria whose buffer status is to be reported;
determining whether an available Uplink (UL) grant size is less than a size of a Long BSR; and
triggering a reduced BSR wherein the reduced BSR is at least one of a truncated BSR, a course BSR and a LCG index field identifying at least one LCG having data available for transmission.

2. The method of claim 1, wherein the LCGs whose buffer status is being reported is determined based on the available UL grant size.

3. The method of claim 1, wherein the LCG threshold criteria indicates that the number of LCGs with data available for transmission is greater than a minimum threshold but less than a maximum threshold.

4. The method of claim 1, wherein the truncated BSR comprises at least information of data available for transmission for at least one of the LCGs.

5. The method of claim 4, wherein the LCGs having the data available for transmission in the truncated BSR is selected based on one of a decreasing order of a priority of LCGs for which the reduced BSR is triggered.

6. The method of claim 1 further comprises clearing the buffer status reporting triggers of LCGs whose buffer status is being reported using the reduced BSR.

7. A user equipment (UE) in wireless communication system, the user equipment comprising:
a memory;
a processor; and
a BSR engine, coupled to the memory and the processor, configured to:
determine whether at least one Logical Channel Groups (LCG) having data available for transmission meets an LCG threshold criteria whose buffer status is to be reported;
determine whether an available Uplink (UL) grant size is less than a size of a Long BSR; and
trigger a reduced BSR wherein the reduced BSR is at least one of a truncated BSR and a course BSR and a LCG index field identifying at least one LCG having data available for transmission.

8. The user equipment of claim 7, wherein the LCGs whose buffer status is being reported is determined based on the available UL grant size.

9. The user equipment of claim 7, wherein the LCG threshold criteria indicates that the number of LCGs with data available for transmission is greater than a minimum threshold but less than a maximum threshold.

10. The user equipment of claim 7, wherein the truncated BSR comprises at least information of data available for transmission for at least one of the LCGs.

11. The user equipment of claim 10, wherein the LCGs having the data available for transmission in the truncated BSR is selected based on one of a decreasing order of a priority of LCGs for which the reduced BSR is triggered.

12. The user equipment of claim 7, wherein the BSR engine is further configured to clear the buffer status reporting triggers of LCGs whose buffer status is being reported using the reduced BSR.
